(19) United States
(12) Patent Application Publication
(10) Pub. No.: US 2020/0145756 A1
(43) Pub. Date: May 7, 2020

(54) HEADSET

(71) Applicant: Merry Electronics(Shenzhen) Co., Ltd., ShenZhen (CN)

(72) Inventors: Hung-Chi Lin, Taichung (TW); Jung-Chu Lu, Taichung (TW); Mao-Hung Lin, Taichung (TW)

(73) Assignee: Merry Electronics(Shenzhen) Co., Ltd., ShenZhen (CN)

(21) Appl. No.: 16/408,443

(22) Filed: May 9, 2019

(30) Foreign Application Priority Data
Nov. 7, 2018 (TW) 107139483

(51) Int. Cl. H04R 5/033; H04R 1/10

(52) U.S. Cl. CPC H04R 5/033; H04R 2201/107; H04R 1/1066; H04R 1/1008

(57) ABSTRACT

A headset including a housing, a speaker, an electrical signal sensor and a processor is provided. The electrical signal sensor is disposed in an internal cavity of the housing. The electrical signal sensor is configured to generate a first electrical signal according to a friction caused when an insertion portion of the housing is removed from an ear canal of an ear and generate a second electrical signal according to the friction caused when the insertion portion is inserted into the ear canal of the ear. The processor is configured to instruct an electronic device to stop playing an audio signal when receiving the first electrical signal and instruct the electronic device to play the audio signal when receiving the second electrical signal, so that the speaker outputs the audio signal.

### CROSS-REFERENCE TO RELATED APPLICATION

This application claims the priority benefit of Taiwan application serial no. 107139483, filed on Nov. 7, 2018. The entirety of the above-mentioned patent application is hereby incorporated by reference herein and made a part of this specification.

### BACKGROUND

### Field of the Invention

The invention relates to a headset and more particularly, to a headset capable of improving convenience of use.

### Description of Related Art

As technology advances, headsets connected to electronic devices have been gradually widely developed. Regarding playback settings of a currently existing headset, an electronic device is mainly operated by a user to stop playing music or start playing music. However, when the headset is removed from an ear or falls off from the ear, the electronic device keeps playing music, which cause power loss of the electron device, and the user will miss the music being played during the period between the headset being removed from the ear and being worn to the ear. As such, the user still has to operate the electronic device to stop playing music, which lead to degraded convenience of use.

### SUMMARY

The invention provides a headset. The headset of the invention is capable of instructing an electronic device to stop playing music according to a friction generated when the headset is removed from an ear and instructing the electronic device to play the music being stopped according to the friction caused when the headset is worn to the ear.

A headset of the invention is electrically coupled to an electronic device. The headset includes a housing, at least one speaker, an electrical signal sensor and a processor. The housing includes an insertion portion and an internal cavity. The insertion portion is configured to be inserted into an ear of a user. The internal cavity is an internal space surrounded by the housing. The at least one speaker is disposed in the internal cavity. The at least one speaker is configured to receive an audio signal of the electronic device and output the audio signal. The electrical signal sensor is disposed at the insertion portion. The electrical signal sensor is configured to generate a first electrical signal according to a friction generated between the insertion portion and an ear canal of the ear when the insertion portion is removed from the ear canal of the ear, and generate a second electrical signal according to the friction generated between the insertion portion and the ear canal of the ear when the insertion portion is inserted into the ear canal of the ear. The processor is electrically coupled to the electrical signal sensor. The processor is configured to receive the first electrical signal or the second electrical signal. When the processor receives the first electrical signal, the processor provides a first control signal corresponding to the first electrical signal to instruct the electronic device to stop playing the audio signal. When the processor receives the second electrical signal, the processor provides a second control signal corresponding to the second electrical signal to instruct the electronic device to play the audio signal, so that the at least one speaker outputs the audio signal.

To sum up, the headset of the invention can generate the first electrical signal according to the friction generated when the headset is removed from the ear and can generate the second electrical signal according to the friction caused when the headset is worn to the ear. The headset can instruct the electronic device to stop the audio signal being played according to the first electrical signal, and instruct the electronic device to play the audio signal that is stopped according to the second electrical signal. In this way, convenience of use can be improved for the user, and power loss of the electronic device during the headset being removed can be reduced.

In order to make the aforementioned features and advantages of the invention more comprehensible, embodiments accompanying figures are described in details below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural diagram illustrating a headset according to an embodiment of the invention.

FIG. 2 is a schematic circuit diagram illustrating a headset and an electronic device according to an embodiment of the invention.

FIG. 3A and FIG. 3B are schematic waveform charts respectively illustrating a first electrical signal and a second electrical signal according to an embodiment of the invention.

FIG. 4 is a flowchart of a first operation according to an embodiment of the invention.

FIG. 5 is a flowchart of a second operation according to an embodiment of the invention.

FIG. 6 is a schematic circuit diagram illustrating a headset and an electronic device according to another embodiment of the invention.

FIG. 7 is a schematic circuit diagram illustrating a band pass filter according to an embodiment of the invention.

### DESCRIPTION OF EMBODIMENTS

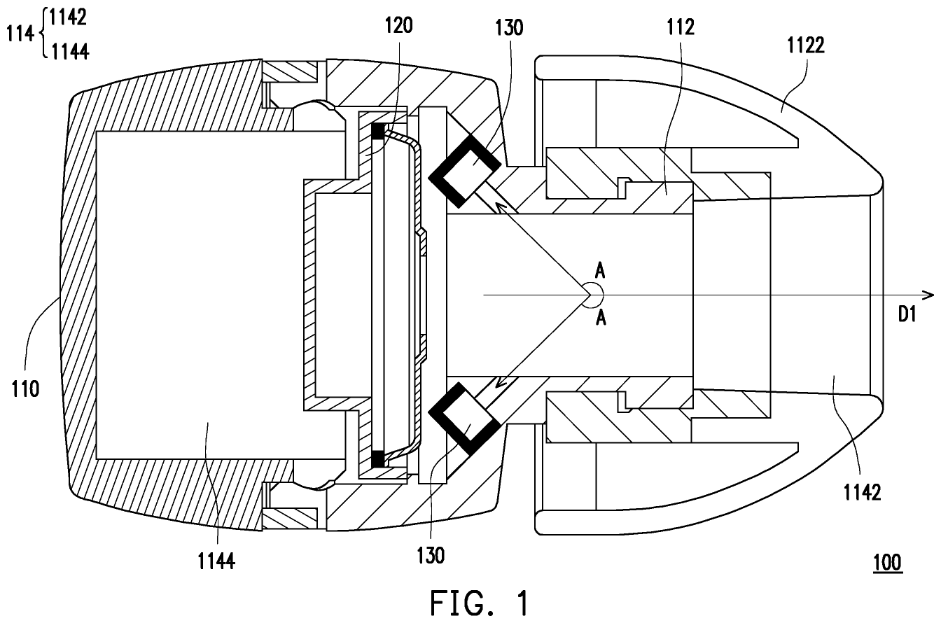

Referring to FIG. 1, FIG. 1 is a schematic structural diagram illustrating a headset according to an embodiment of the invention. In the embodiment illustrated in FIG. 1, a headset 100 is adapted to perform wired or wireless signal connection with an external electronic device. The headset 100 includes a housing 110, a speaker 120, an electrical signal sensor 130 and a processor 140. The housing 110 includes an insertion portion 112 and an internal cavity 114. The insertion portion 112 of the housing 110 is configured to be inserted into an ear of a user, so as to fix the headset 100 to the ear. The internal cavity 114 is an internal space surrounded by the housing 110. The speaker 120 is disposed in the internal cavity 114. The speaker 120 is configured to receive an audio signal of the electronic device and output the audio signal. In the embodiment, the speaker 120 may be one or more, without any particular limitation.

The internal cavity 114 is divided into a front cavity 1142 and a rear cavity 1144 due to the disposition of the speaker 120. The front cavity 1142 may serve as a transmission channel for playing the audio signal. The transmission channel extends from the speaker 120 along a first direction D1. The rear cavity 1144 is a space surrounded by the internal cavity 114 and the speaker 120. The electrical signal sensor 130 is disposed at the housing 110. The electrical signal sensor 130 is configured to generate an electrical signal according to a friction caused by the insertion portion 112 with respect to an ear canal of the ear.

In the present embodiment, the insertion portion 112 includes an earplug element 1122. The earplug element 1122 is configured to enhance the fixing effect and friction effect between the insertion portion 112 and the ear canal. The earplug element 1122 of the present embodiment may be a silicon earplug, a rubber earplug or a foam earplug. In other embodiments, the insertion portion 112 may also not include the earplug element 1122, and the invention is not limited to the embodiment where the insertion portion 112 includes the earplug element 1122, as illustrated in FIG. 1.

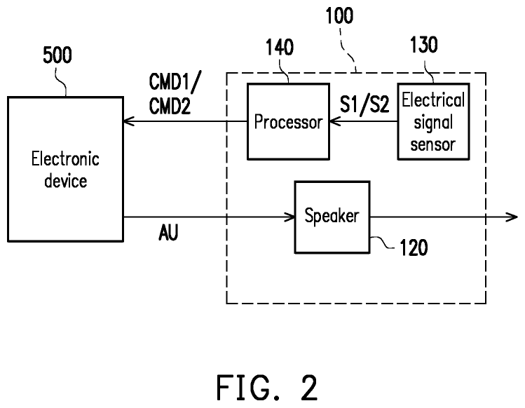

Referring to FIG. 1 and FIG. 2 simultaneously, FIG. 2 is a schematic circuit diagram illustrating the headset and an electronic device according to an embodiment of the invention. In the present embodiment, the electrical signal sensor 130 is disposed at the insertion portion 112. The electrical signal sensor 130 is configured to receive a first electrical signal S1 or a second electrical signal S2 at a receiving angle A facing toward the transmission channel and with respect to the transmission direction D1, so as to improve a sensing sensitivity of the electrical signal sensor 130.

In some embodiments, the receiving angle A may range from 120° to 150°. In some embodiments, the receiving angle A may be 135°.

In the present embodiment, the electrical signal sensor 130 may be implemented by a microphone array. The microphone array may generate a transient change of a voltage bias by sensing the friction generated between the insertion portion 112 and the ear canal, thereby generating the first electrical signal S1 or the second electrical signal S2. In order to improve the sensing sensitivity and a signal-to-noise ratio (SNR) of the electrical signal sensor 130, in some embodiments, the electrical signal sensor 130 may be implemented by a microphone array with a mesh removed. In some embodiments, the electrical signal sensor 130 of the present embodiment may be implemented by a microphone array with a sensitivity level ranging from −26 dB to −42 dB. In some embodiments, the electrical signal sensor 130 may be implemented by a microphone array with a sensitivity level ranging from −26 dB to −42 dB and with a mesh removed.

The processor 140 is coupled to the electrical signal sensor 130. The processor 140 is configured to receive the electrical signal provided by the electrical signal sensor 130 and instruct an electronic device 500 to turn off an audio signal AU or turn on the audio signal AU according to the received electrical signal. It should be noted that turning off the audio signal AU refers to stopping or suspending the audio signal AU being played, while turning on the audio signal AU refers to starting the playback of the audio signal AU that has been stopped or suspended.

The electronic device 500 of the present embodiment may be a personal digital assistant (PDA), a mobile phone, a tablet computer, a notebook computer, a desktop computer or other devices. In the present embodiment, the processor 140 is disposed in the headset 100. In some embodiments, the processor 140 may be disposed in the electronic device 500.

Furthermore, in the present embodiment, the speaker 120 of the headset 100 is configured to receive the audio signal AU provided by the electronic device 500 and output the audio signal AU. The electrical signal sensor 130 is configured to generate the first electrical signal S1 according to the friction generated between the insertion portion 112 and the ear canal of the ear when the insertion portion 112 is removed from the ear canal of the ear. Namely, when the headset 100 is removed or falls off from the ear, the electrical signal sensor 130 generates the first electrical signal S1 according to the friction condition between the insertion portion 112 and the ear canal. In addition, the electrical signal sensor 130 is configured to generate the second electrical signal S2 according to a friction generated between the insertion portion 112 and the ear canal of the ear when the insertion portion 112 is inserted into the ear canal of the ear. Namely, when the headset 100 is worn to the ear, the electrical signal sensor 130 generates the second electrical signal S2 according to another friction condition between the insertion portion 112 and the ear canal.

In some embodiments, the first electrical signal S1 and the second electrical signal S2 may be electrical signals generated from the frictions, and may be electrical signals generated from pressure changes.

The processor 140 is electrically coupled to the electrical signal sensor 130. The processor 140 is configured to receive the first electrical signal S1 or the second electrical signal S2 provided by the electrical signal sensor 130. When the processor 140 receives the first electrical signal S1, the processor 140 provides a first control signal CMD1 corresponding to the first electrical signal S1 to instruct the electronic device 500 to turn off the audio signal AU. When the processor 140 receives the second electrical signal S2, the processor 140 provides a second control signal CMD2 corresponding to the second electrical signal S2 to instruct the electronic device 500 to turn on the audio signal AU, so that the speaker 120 outputs the audio signal AU. In this way, convenience of operation may be improved for the user, and power loss of the electronic device 500 during the headset 100 being removed may be reduced. In the present embodiment, the processor 140 may be a central processing unit (CPU) or any other programmable microprocessor for general or special use, a digital signal processor (DSP), a programmable controller, an application specific integrated circuit (ASIC), a programmable logic device (PLD) or other similar devices, or a combination of these devices, which a computer program may be loaded to for execution.

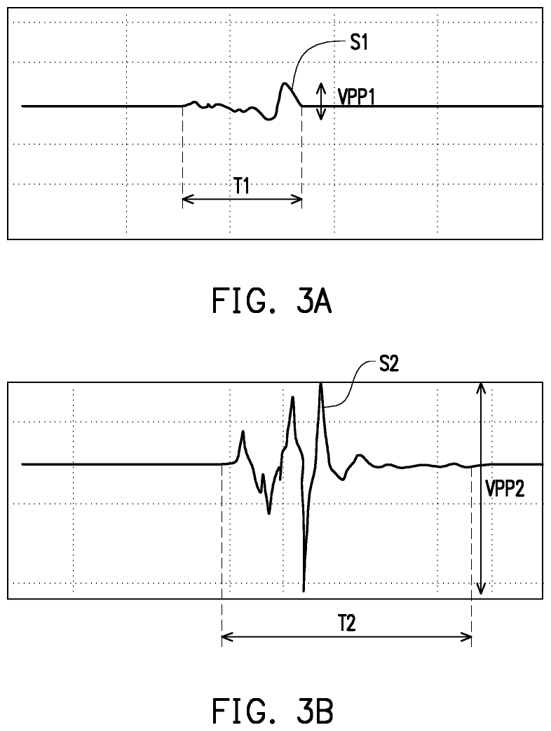

Referring to FIG. 2, FIG. 3A and FIG. 3B, FIG. 3A and FIG. 3B are schematic waveform charts respectively illustrating the first electrical signal and the second electrical signal according to an embodiment of the invention. In the present embodiment, a peak to peak voltage (Vpp) level VPP1 of the first electrical signal S1 is within a first voltage range, e.g., from 100 mV to 200 mV. A Vpp level VPP2 of the second electrical signal S2 is within a second voltage range, e.g., from 500 mV to 1000 mV. Namely, the Vpp level VPP1 of the first electrical signal S1 is lower than the Vpp level VPP2 of the second electrical signal S2. Thus, based on a difference between the Vpp level VPP1 of the first electrical signal S1 and the Vpp level VPP2 of the second electrical signal S2, the processor 140 may identify the first electrical signal S1 or the second electrical signal S2 according to the Vpp level.

In the present embodiment, the processor 140 may provide a reference voltage whose Vpp level is equal to, for example, 250 mV and compare the reference voltage and a received electrical signal to identify the first electrical signal S1 and the second electrical signal S2. As the Vpp level VPP1 of the first electrical signal S1 is smaller than a level of the reference voltage, the processor 140 may identify that the electrical signal which is smaller than the reference voltage is the first electrical signal S1. That is to say, when the first electrical signal S1 is identified by the processor 140, the insertion portion 112 of the headset 100 has departed from the ear canal. The processor 140 provides the first control signal CMD1 corresponding to the first electrical signal S1 to the electronic device 500, thereby instructing the electronic device 500 to turn off the audio signal AU. On the other hand, as the Vpp level of the second electrical signal S2 is greater than the level of the reference voltage, the processor 140 may identify that the electrical signal which is greater than the reference voltage is the second electrical signal S2. That is to say, when the second electrical signal S2 is identified by the processor 140, the insertion portion 112 of the headset 100 has been inserted into the ear canal. The processor 140 provides the control signal CMD2 corresponding to the second electrical signal S2, thereby instructing the electronic device 500 to start the audio signal AU.

In some embodiments, the processor 140 may provide a minimum reference voltage (for example, having a Vpp level equal to 50 mV). The processor 140 may identify that an electrical signal which is smaller than the minimum reference voltage is neither the first electrical signal S1 nor the second electrical signal S2 and does not provide the control signals CMD1 and CMD2. In some embodiments, the processor 140 may also provide a maximum reference voltage (for example, having a Vpp level equal to 1200 mV). The processor 140 may identify that an electrical signal which is greater than the maximum reference voltage is neither the first electrical signal S1 nor the second electrical signal S2, and does not provide the control signals CMD1 and CMD2.

In the present embodiment, a signal time length T1 of the first electrical signal S1 is within a first time length range, e.g., from 100 msec to 200 msec. A signal time length T2 of the second electrical signal S2 is within a second time length range, e.g., from 500 msec to 1000 msec. Thus, based on a difference between the signal time length T1 of the first electrical signal S1 and the signal time length T2 of the second electrical signal S2, the processor 140 may identify the first electrical signal S1 and the second electrical signal S2 according to the signal time length.

In some embodiments, the processor 140 may provide a predetermined time length (for example, having a signal time length equal to 50 msec). A triggering time length of the first electrical signal S1 and a triggering time length of the second electrical signal S2 are greater than or equal to the predetermined time length. Thus, the processor 140 may identify that an electrical signal with a time length which is smaller than the predetermined time length is neither the first electrical signal S1 nor the second electrical signal S2 and thus, does not provide the control signals CMD1 and CMD2. In some embodiments, the processor 140 may also provide a maximum reference time length (for example, having a signal time length equal to 1600 msec). The processor 140 may identify that an electrical signal whose time length is greater than the maximum reference time length is neither the first electrical signal S1 nor the second electrical signal S2, and does not provide the control signals CMD1 and CMD2.

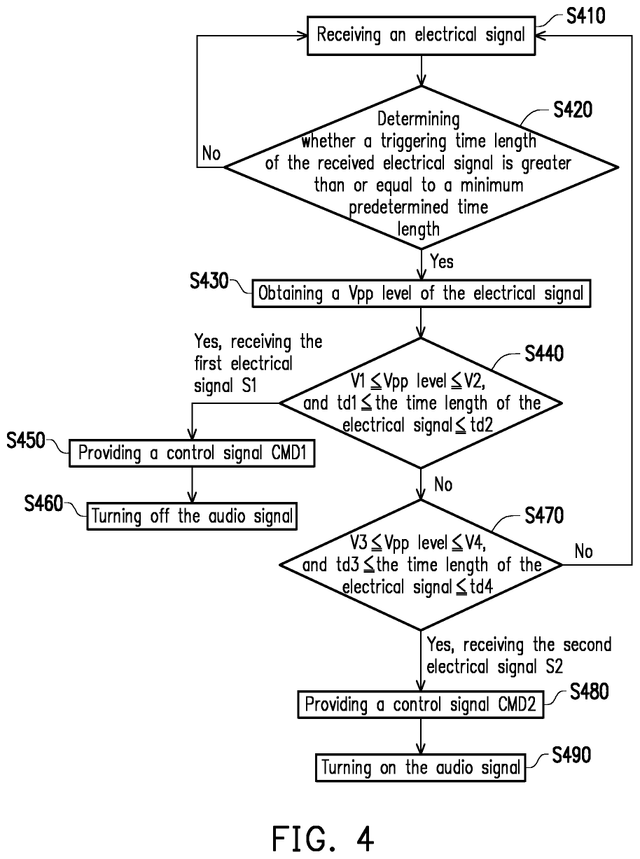

Specifically, referring to FIG. 2 and FIG. 4, FIG. 4 is a flowchart of a first operation according to an embodiment of the invention. In step S410, the processor 140 starts to identify the first electrical signal S1 and the second electrical signal S2 according to the triggering time lengths and the Vpp levels. In step S410, the processor 140, after receiving the electrical signal provided by the electrical signal sensor 130, proceeds to step S420. In step S420, the processor 140 determines whether a triggering time length of the received electrical signal is greater than or equal to a predetermined time length (e.g., 50 msec). When determining that the triggering time length of the received electrical signal is greater than or equal to the predetermined time length, the processor 140 proceeds to step S430. Or otherwise, when determining that the triggering time length of the received electrical signal is smaller than the predetermined time length, the processor 140 returns to step S410.

In step S430, the processor 140 obtains a Vpp level of the electrical signal. The processor 140 then proceeds to step S440 to determine whether the Vpp level of the electrical signal is within a first voltage value range (for example, a range from a voltage level V1, where V1=100 mV, to a voltage level V2, where V2=200 mV) and determine whether the triggering time length is within a first time length range (for example, a range from a time length td1=100 msec, to a time length td2=200 msec). When the processor 140 determines that the Vpp level of the electrical signal is within the first voltage value range, and the triggering time length is within the first time length range, the processor 140 identifies the received electrical signal as the first electrical signal S1 and proceeds to step S450 to provide the control signal CMD1 corresponding to the first electrical signal S1, thereby, in step S460, instructing the electronic device 500 to turn off the audio signal AU.

Returning to step S430, when the processor 140 determines that the Vpp level of the electrical signal is not within the first voltage value range and/or that the triggering time length of the electrical signal is not within the first time length range, the processor 140 does not identify the received electrical signal as the first electrical signal S1 and proceeds to step S470. In step S470, the processor 140 further determines whether the Vpp level of the electrical signal is within a second voltage value range (for example, a range from a voltage level V3=500 mV, to a voltage level V4=1000 mV) and determines whether the triggering time length is within a second time length range (for example, a range from a time length td3=500 msec, to a time length td4=1000). When the processor 140 determines that the Vpp level of the electrical signal is within the second voltage value range, and the triggering time length is within the second time length range, the processor 140 identifies the received electrical signal as the second electrical signal S1 and proceeds to step S480 to provide the control signal CMD2 corresponding to the second electrical signal S2, thereby, in step S490, instructing the electronic device 500 to turn on the audio signal AU.

Returning to step S470, when the processor 140 determines that the Vpp level of the electrical signal is not within the second voltage value range and/or that the triggering time length of the electrical signal is not within the second time length range, the processor 140 does not identify the received electrical signal as the second electrical signal S2 or the first electrical signal S1 and returns to step S410.

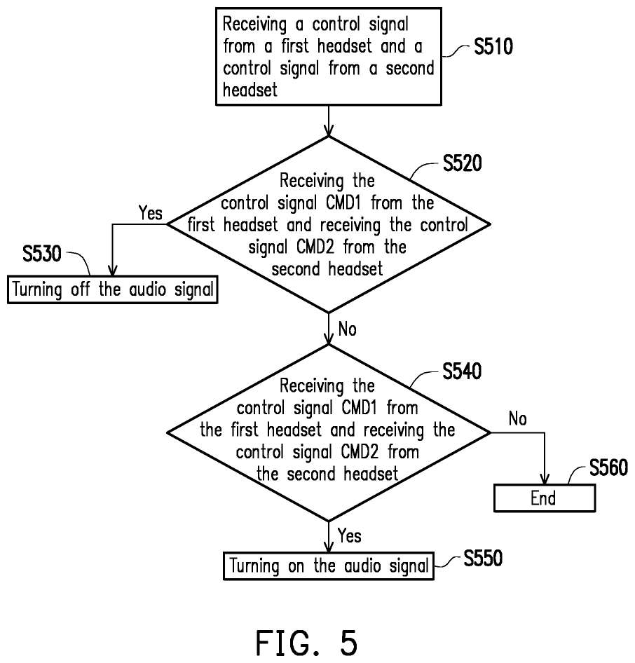

The operation flow illustrated in FIG. 4 may be applicable to a scenario that a single headset is worn to the left or the right ear. Referring to FIG. 2, FIG. 4 and FIG. 5, FIG. 5 is a flowchart of a second operation according to an embodiment of the invention. The operation process illustrated in FIG. 5 may be applicable to a scenario that a dual-headset device is worn to the left and the right ears. In the present embodiment, first, the electronic device 500, in step S510, receives a control signal from a first headset and a control signal from a second headset. The first headset is one worn to the left ear, and the second headset is one worn to the right ear. Regarding the method of providing the control signals, the descriptions related to steps S410-S450, S470 and S480 illustrated in FIG. 4 may be referred to.

In step S520, the electronic device 500 determines whether the control signal from the first headset is the control signal CMD1 corresponding to the first electrical signal S1 and determines whether the control signal from the second headset is the control signal CMD1 corresponding to the first electrical signal S1. The electronic device 500, when determining that the control signal from the first headset is the control signal CMD1, and the control signal from the second headset is also the control signal CMD1, proceeds to step S530. That is to say, when the electronic device 500 determines that the control signals from the first headset and the second headset are both the control signal CMD1, step S530 is entered to turn off the audio signal AU. Thus, the electronic device 500, in steps S510-S530, determines to turn off the audio signal AU in a condition that the first headset and the second headset are both removed or fall off.

By contrast, the electronic device 500, in step S520, when determining that one of the control signals from the first headset and the second headset is not the control signal CMD1, proceeds to step S540. In step S540, the electronic device 500 further determines whether the control signal from the first headset is the control signal CMD2 corresponding to the second electrical signal S2 and determines whether the control signal from the second headset is the control signal CMD2 corresponding to the second electrical signal S2. The electronic device 500, when determining that the control signal from the first headset is the control signal CMD2, and the control signal from the second headset is also the control signal CMD2, proceeds to step S550. That is to say, when the electronic device 500 determines that the control signals from the first headset and the second headset are both the control signal CMD2, step S550 is entered to turn on the audio signal AU. Thus, the electronic device 500, in steps S510, S520, S540 and S550, determines to turn on the audio signal AU in a condition that the first headset and the second headset are both worn.

On the other hand, when the electronic device 500, in step S540, determines that one of the control signals from the first headset and the second headset is not the control signal CMD2, namely, by combining the determination results of steps S520 and S540, it is indicated that the control signals from the first headset and the second headset are different control signals, step S560 is entered, and the process flow ends. In some embodiments, the process may return to step S410 illustrated in FIG. 4 after step S560.

Based on the present embodiments described with reference to FIG. 2, FIG. 4 and FIG. 5, the user may perform the settings of turning on/turning off the audio signal AU of the electronic device 500 through an application provided by the electronic device 500 and according to the wearing manner of the headset expected by the user.

Taking another example for description, according to the same embodiment, the user configures the electronic device 500 through the application provided by the electronic device 500. The electronic device 500 is configured to turn off the audio signal AU when one of the first headset and the second headset is removed or fall off. Namely, the user may set the electronic device 500 to turn off the audio signal AU whenever receiving a single control signal CMD1 corresponding to the first electrical signal S1.

Taking another example for description, according to the same embodiment, the user may configure the electronic device 500 to turn on the audio signal AU when one of the first headset and the second headset is worn to the ear. Namely, the user may configure the electronic device 500 to turn on the audio signal AU when receiving a single control signal CMD2 corresponding to the second electrical signal S2.

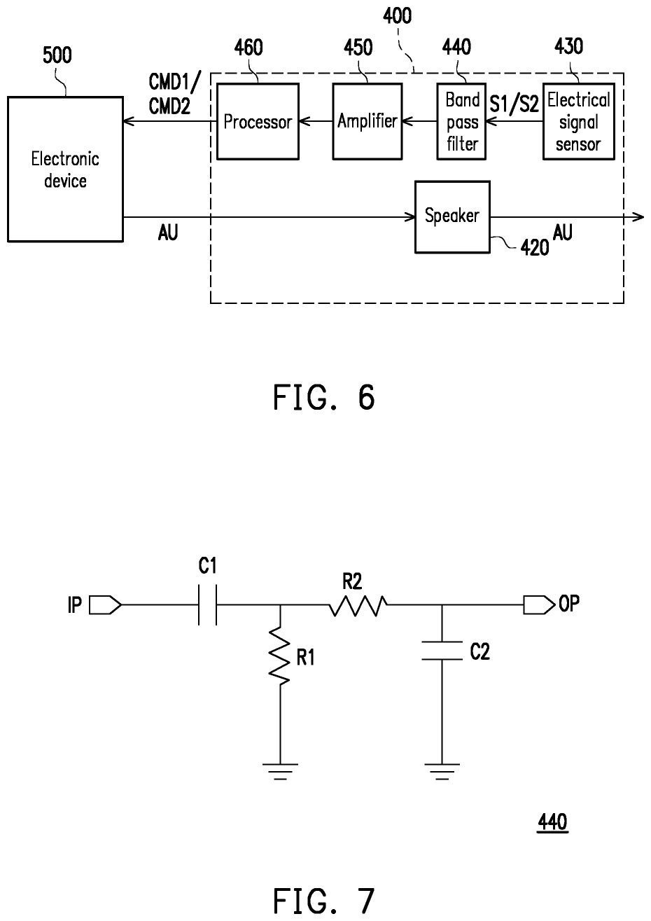

Referring to FIG. 6, FIG. 6 is a schematic circuit diagram illustrating the headset and an electronic device according to an embodiment of the invention. Different from the embodiment in FIG. 2, a headset 400 illustrated in FIG. 6 further includes a band pass filter 440 and an amplifier 450. The band pass filter 440 is coupled to an electrical signal sensor 430. The band pass filter 440 is configured to filter out signals of the first electrical signal S1 and the second electrical signal S2 that are greater than a first frequency, and filter out the first electrical signal S1 and the second electrical signal S2 that is smaller than a second frequency. The first frequency is greater than the second frequency. For instance, the first frequency is 30 Hertz, and the second frequency is 10 Hertz. Thus, the band pass filter 440 may filter out signals of the first electrical signal S1 and the second electrical signal S2 that is greater than 30 Hertz, for example, the audio signal AU or an audio signal from the external. The band pass filter 440 may also filter out signals of less than 10 Hertz in the first electrical signal S1 and the second electrical signal S2, such as a circuit noise. The band pass filter 440 may retain signals between 10 and 30 Hertz in the first electrical signal S1 and the second electrical signal S2. In this way, an identification error due to the audio signal AU, the audio signal from the external and the circuit noise may be prevented from occurring to a processor 460.

Referring to FIG. 7, FIG. 7 is a schematic circuit diagram illustrating the band pass filter according to an embodiment of the invention. The band pass filter 440 includes capacitors C1 and C2 and resistors R1 and R2. A first terminal of the capacitor C1 serves as an input terminal IP of the band pass filter 440 and is coupled to an electrical signal sensor. A first terminal of the resistor R1 is coupled to a second terminal of the capacitor C1. A second terminal of the resistor R1 is coupled to a reference low voltage level (e.g., a grounding voltage level). A first terminal of the resistor R2 is coupled to the second terminal of the capacitor C1. A first terminal of the capacitor C2 is coupled to a second terminal of the resistor R2 and is employed together with the second terminal of the resistor R2 as an output terminal OP of the band pass filter 440. A second terminal of the capacitor C2 is coupled to the reference low voltage level.

Herein, for example, a capacitance of the capacitor C1 is 10 microfarads (μF), a capacitance of the capacitor C2 is 1 μF, a resistance of the resistor R1 is 1500 ohms, and a resistance of the resistor R2 is 5000 ohms.

It should be understood that the band pass filter of the invention is not limited to that of the embodiment illustrated in FIG. 7, any band filter circuit or device configured to filter audio signals and circuit noise is also covered by the scope of the invention.

Returning to FIG. 6, in the embodiment illustrated in FIG. 6, the amplifier 450 is coupled between the band pass filter 440 and the processor 460. The amplifier 450 receives the first electrical signal S1/the second electrical signal S2 provided by the electrical signal sensor 440 and performs gain on the first electrical signal S1/the second electrical signal S2, thereby improving accuracy of the processor 460 in identifying the first electrical signal S1/the second electrical signal S2. In the embodiment, the gain of the amplifier 450 conforms to a formula: −0.5*VCC/VS>GSA>0.5*VCC/VS, herein GSA is the gain of the amplifier 450, VCC is a system voltage level, and VS is a voltage level of the first electrical signal S1/the second electrical signal S2.

In the invention, the band pass filter is coupled between the amplifier and the processor according to a design requirement. The coupling manner of the band pass filter and the amplifier is not limited to the coupling manner of the band pass filter 440 and the amplifier 450 as illustrated in FIG. 6.

Based on the above, the headset of the invention can generate the first electrical signal according to the friction caused when the headset is removed from the ear and can generate the second electrical signal according to the friction caused when the headset is worn to the ear. The headset can further instruct the electronic device to turn off the audio signal being played according to the first electrical signal and instruct the electronic device to turn on the audio signal according to the second electrical signal. In this way, the convenience of use can be improved for the user, and power loss of the electronic device that may be caused during the headset being removed can be reduced.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A headset, electrically coupled to an electronic device, the headset comprising:
a housing, comprising:
an insertion portion, configured to be inserted into an ear of a user; and
an internal cavity, being an internal space surrounded by the housing;
at least one speaker, disposed in the internal cavity and configured to receive an audio signal of the electronic device and output the audio signal;
an electrical signal sensor, disposed at the insertion portion, and configured to generate a first electrical signal according to a friction generated between the insertion portion and an ear canal of the ear when the insertion portion is removed from the ear canal of the ear, and generate a second electrical signal according to the friction generated between the insertion portion and the ear canal of the ear when the insertion portion is inserted into the ear canal of the ear; and
a processor, electrically coupled to the electrical signal sensor, and configured to receive the first electrical signal or the second electrical signal, provide a first control signal corresponding to the first electrical signal to instruct the electronic device to turn off the audio signal when the processor receives the first electrical signal, and provide a second control signal corresponding to the second electrical signal to instruct the electronic device to turn on the audio signal when the processor receives the second electrical signal, so that the at least one speaker outputs the audio signal.

2. The headset according to claim 1, wherein the insertion portion extends out from a front edge of the housing, so that a part of the internal cavity enters the ear canal when the insertion portion is inserted into the ear canal of the ear.

3. The headset according to claim 1, wherein when the insertion portion is inserted into the ear, the electrical signal sensor is located in the ear canal or located at an exit of the ear canal.

4. The headset according to claim 1, wherein the insertion portion comprises an earplug element.

5. The headset according to claim 1, wherein the electrical signal sensor is a microphone array.

6. The headset according to claim 1, wherein the electrical signal sensor is a microphone array with a mesh removed.

7. The headset according to claim 1, wherein
the internal cavity comprises a transmission channel configured to propagate the audio signal,
the transmission channel extends from the at least one speaker along a transmission direction,
the electrical signal sensor is configured to receive the first electrical signal or the second electrical signal at a receiving angle facing toward the transmission channel and with respect to the transmission direction.

8. The headset according to claim 7, wherein the receiving angle is 135°.

9. The headset according to claim 1, wherein the processor is further configured to:
identify the first electrical signal and the second electrical signal according to a triggering time length and a peak to peak voltage level.

10. The headset according to claim 9, wherein
a triggering time length of the first electrical signal and a triggering time length of the second electrical signal are greater than or equal to a predetermined time period, and
a peak to peak voltage level of the first electrical signal is less than a peak to peak voltage level of the second electrical signal.

11. The headset according to claim 1, wherein the headset further comprises:
a band pass filter, coupled to the electrical signal sensor and configured to filter out the first electrical signal and the second electrical signal that is greater than a first frequency, and filter out the first electrical signal and the second electrical signal that is less than a second frequency,
wherein the first frequency is greater than the second frequency.

12. The headset according to claim 1, wherein the first frequency is 30 Hertz, and the second frequency is 10 Hertz.

13. The headset according to claim 1, wherein the headset further comprises:
an amplifier, coupled to the electrical signal sensor and configured to amplify the first electrical signal and the second electrical signal.
